(19) United States
(12) Patent Application Publication
(10) Pub. No.: US 2020/0379428 A1
(43) Pub. Date: Dec. 3, 2020

(54) MACHINE TOOL CONTROL DEVICE AND MACHINE TOOL

(71) Applicant: FANUC CORPORATION, Yamanashi (JP)

(72) Inventor: Takuya HIRANUMA, Yamanashi (JP)

(73) Assignee: FANUC CORPORATION, Yamanashi (JP)

(21) Appl. No.: 16/857,424

(22) Filed: Apr. 24, 2020

(30) Foreign Application Priority Data
May 30, 2019 (JP) 2019-101189
Jun. 27, 2019 (JP) 2019-120085

(51) Int. Cl. G05B 19/402

(52) U.S. Cl. CPC G05B 19/402; G05B 2219/35519

(57) ABSTRACT

A machine tool control device according to as embodiment of the present disclosure is a machine tool control device which controls a machine tool having a plurality of drive axes, the machine tool control device including: an input acceptance unit which accepts an input from outside; and a modeling unit which models a driven body which is driven by the drive axes on virtual 3D space, in which the input acceptance unit has a parameter setting unit is which a parameter designating an operating condition of the plurality of drive axes is inputted, and in which the modeling unit includes: a driven body arrangement unit which arranges a model of the driven body on the virtual 3D space, based on the parameter inputted in the parameter setting unit, and a projection image generation unit which generates a projection image of the model of the driven body arranged by the driven body arrangement unit.

This application is based on and claims the benefit of priority from Japanese Patent Application No. 2019-101189, filed on 30 May 2019, and Japanese Patent Application No. 2019-120085, filed on 27 Jun. 2019, the content of which is incorporated herein by reference.

### BACKGROUND OF THE INVENTION

### Field of the Invention

The present invention relates to a machine tool control device and a machine tool.

### Related Art

Generally, a machine tool control device which controls a machine tool causes the machine tool to operate following a machining program. With such a machine tool control device, it is necessary to set parameters specifying the mechanical configuration of the machine tool, as information established as the basis of the machining operation. As such parameters, for example, numerical information such as the mobile range, relative positional relationship of each drive axis, etc. for a plurality of drive axes can be exemplified.

In order to make such parameters easily settable, a parameter setting device for a numerical control machine that displays a parameter setting screen in an interactive mode has been proposed (for example, refer to Patent Document 1).

Patent Document 1: Japanese Unexamined Patent Application, Publication No. 2003-202910

### SUMMARY OF THE INVENTION

Using technology such as that of Patent Document 1, it is possible to set the values of all parameters necessary so long as setting parameters by inputting the values of parameters in a form on a screen. However, from the input screen of parameters, it is difficult to imagine the configuration or shape of the machine tool, and it is not possible for the operator to confirm whether the parameters can be calculated and inputted accurately. Therefore, a machine tool control device is desired which can easily confirm whether the inputted parameters are appropriate.

A machine tool control device according to an aspect of the present disclosure is a machine tool control device which controls a machine tool having a plurality of drive axes, the machine tool control device including: an input acceptance unit which accepts an input from outside; and a modeling unit which models a driven body which is driven by the drive axes on virtual 3D space, in which the input acceptance unite, has a parameter setting unit in which a parameter designating an operating condition of the plurality of drive axes is inputted, and in which the modeling unit includes: a driven body arrangement unit which arranges a model of the driven body on the virtual 3D space, based on the parameter inputted in the parameter setting unit, and a projection image generation unit which generates a projection image of the model of the driven body arranged by the driven body arrangement unit.

According to the machine tool control device of the present disclosure, it is possible to easily confirm whether the inputted parameters are appropriate.

### BRIEF DESCRIPTION OF THE DRAWINGS

FIG. 1 is a block diagram showing the configuration of a machine tool control device according to an embodiment of the present disclosure;

FIG. 2 is a view exemplifying the relationship between a driven body model and projection images in the machine tool control device in FIG. 1;

FIG. 3 is an example of the projection image generated in the machine tool control device in FIG. 1; and

FIG. 4 is a view exemplifying an input screen displayed on the machine tool control device in FIG. 1.

### DETAILED DESCRIPTION OF THE INVENTION

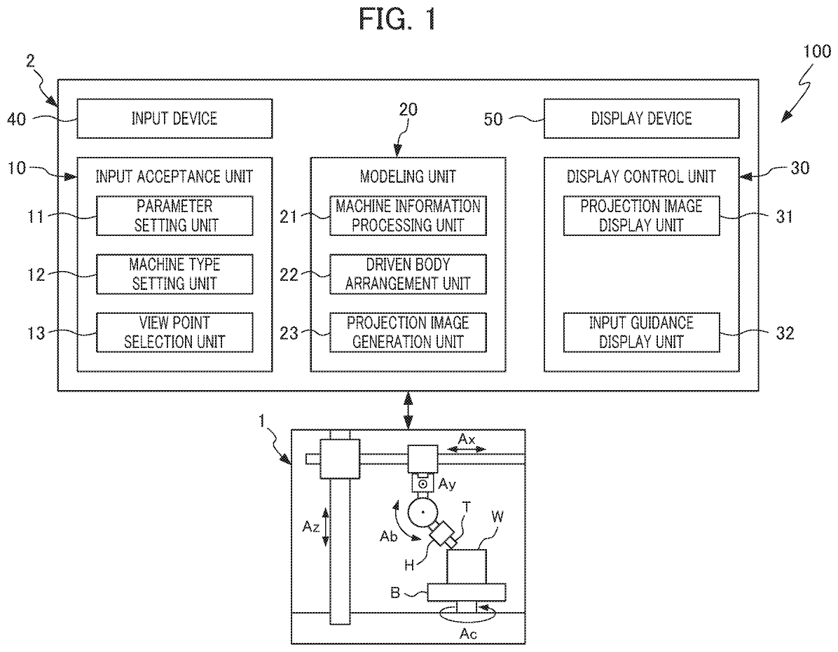

Hereinafter, an embodiment of the present disclosure will be explained while referencing the drawings FIG. 1 is a block diagram showing the configuration of a machine tool 100 according to the embodiment of the present disclosure. The machine tool 100 includes: a machining device 1 having a plurality of drive axes; and a machine tool control device 2 which controls the machining device 1. The machine tool control device 2 is an embodiment of a machine tool control device according to the present disclosure.

The machining device 1 can be established as a device that cuts a workpiece W retained on a table B, for example, by way of a tool T retained to a machining head H, and has a plurality of drive axes capable of relatively moving the tool T (machining head H) in relation to the workpiece W (table B). The specific axis configuration of the machining device 1 is not particularly limited; however, as an example, the machining device 1 can be established as a 5-axis machining device having, as the plurality of drive axes, the three orthogonal linear motion axes Ax, Ay, Az, a rotary axis Ab which is parallel to the linear motion axis Az, and a rotary axis Ac which is parallel to the linear motion axis Az.

The machine tool control device 2 controls the respective drive axes Ax, Ay, Az, Ab, Ac of the machining device 1. This machine tool control device 2 can be realized by in the appropriate control programs in a computer device having a CPU, memory, etc. This machine tool control device 2 can be configured by a numerical control device fixed to the machining device 1. In addition, the machine tool control device 2 is provided so a part or the entirety thereof is distanced from the numerical control device of the machine tool control device 2, and may be configured by a management server which manages one or a plurality of numerical control devices. In addition, a part or the entirety of the machine tool control device 2 may be jointly used in a plurality of machine tools.

The machine tool control device 2 includes: an input acceptance unit 10 which processes input from outside; a modeling unit 20 which models a driven body driven by the drive axes Ax, Ay, Az, Ab, Ac on virtual 3-D space, and generates an image of the driven body model made by modeling the driven body; and a display control unit 30 which performs display to aid the appropriate input of the operator to the input acceptance unit 10, and display to present an image generated by the modeling unit 20 to the operator. In addition, the machine tool control device 2 includes: an input device 40 enabling input by the operator; and a display device 50 which can be used in order to display an image by the display control unit 30. The input acceptance unit 10, modeling unit 20 and display control unit 30 are units classified by the functions of the control program for realizing the machine tool control device 2, and may not necessarily be clearly distinguishable in the functions thereof and program structure.

The input acceptance unit 10 controls processing of accepting input from the operator, processing of reading of removable recording media in the machine tool control device 2, processing of accepting information input via wired or wireless communication from an external device, etc. The input acceptance unit 10 has a parameter setting unit 11 to which parameters designating operating conditions of the plurality of drive axes are inputted; a machine type setting unit 12 to which machine type information specifying the mechanical configuration of the machining device 1 is selected; and a visual point selecting unit 13 in which a visual point of an image to be generated by the modeling unit 20 is selected.

The parameter setting unit 11 accepts the input of parameters numerically controlling the machining device 1, and hands over the inputted parameters to the modeling unit 20. As the parameters accepted by the parameter setting unit 11, it can include numerical values specifying the movement amount or position of the machining device 1. The parameter setting unit 11 distinguishes the plurality of inputted parameters to be associated with a magic number, respectively.

The machine type setting unit 12 accepts the machine type selection information input which selects the axis configuration of the machining device 1, and hands over the inputted machine type selection information to the modeling unit 20. As the machine type selected in the machine type selection unit 12, for example, it is possible to exemplify a 3-axis machining device, tool rotating-type 4-axis machining device, table rotating-type 4-axis machining device, tool rotating-type 5-axis machining device, table rotating-type 5-axis machining device, and mixed-type 5-axis machining device.

The view point selection unit 13 accepts input of view point selection information which selects the view point of an image to be generated by the modeling unit 20, and hands over the inputted view point selection information to the modeling unit 20. The view point selection unit 13 may be configured so as to be able to select one view point from among a plurality of view points set in advance, or may be configured so as to be able to select any view point position.

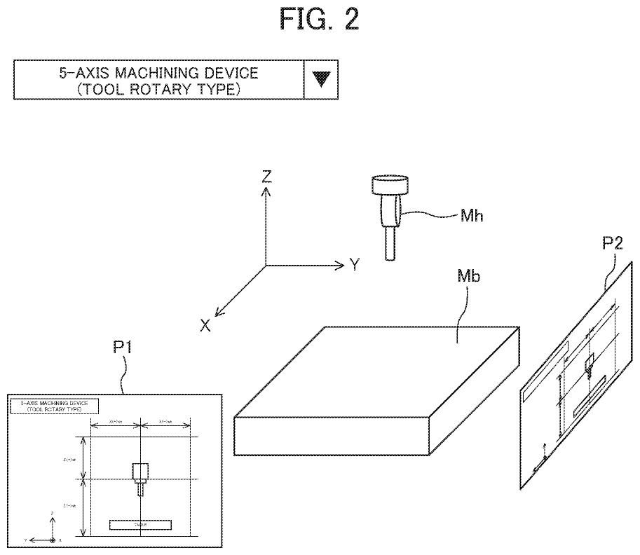

The modeling unit 20 includes: a machine information processing unit 21 which stores a plurality of machine type information sets specifying the configurations of the plurality of drive axes Ax, Ay, Az, Ab, Ac; a driven body arrangement unit 22 which arranges driven body models Mh, Mp modeling one or a plurality of driven bodies which is driven by the drive axes Ax, Ay, Az, ab, Ac of the machining device 1 on virtual 3D space as shown in FIG. 2, based on the parameters inputted to the parameter setting unit 11; and a projection image generation unit 23 which generates projection images P1, P2 (refer to FIG. 2) of the driven body models Mh, Mp arranged by the driven. body arrangement unit 22. In the illustrated example, as the driven body model arranged by the driven body arrangement unit 22, it is possible to establish the model Mh of the machining head H having the tool T and model Mb of the table B of the machining device 1.

The machine information processing unit 21 specifies the axis configuration of the drive axes Ax, Ay, Az, Ab, Ac based on the machine type selection information inputted from the machine type setting unit 12. Then, the machine information processing unit 21 supplies, to the driven body arrangement unit 22, a relational expression calculating the position (including posture) of the driven body model Mh, Mp from the parameters inputted to the parameter setting unit 11 based on the axis configuration, and the form of the driven body model Mh, Mp to be arranged by the driven body arrangement unit 22. The driven body model Mh, Mp can be established in a form schematically indicating the respective drive axes, as exemplified in FIG. 2. In other words, by having the machine information processing unit 21, the machine tool control device 2 can control a plurality of the machining devices 1 having different axis configurations.

The driven body arrangement unit 22 models the driven body model corresponding to the configuration of the drive axes specified by the machine type selection information inputted from the machine type setting unit 12 on virtual 3D space. The driven body arrangement unit 22 calculates, from the parameters inputted to the parameter setting unit 11, the positions of the driven body models Mh, Mb in virtual 3D space, based on the relational expression supplied from the machine information processing unit 21. In addition, the driven body arrangement unit 22 may arrange the reference point in the machining device 1 on virtual 3D space, with the reference of the positions of the driven body models Mh, Mb.

The driven body models Mh, Mb arranged by the driven body arrangement unit 22 can be established as schematic models having a minimal form which can specify the relative position. In addition, the driven body model Mh of the machining head H is preferably established in a form reproducing the angular position of the rotary axis Ab and the offset (length) of the tool T.

The driven body arrangement unit 22, prior to the machine type information being selected by the machine type setting unit 12, may be configured so as not to arrange the driven body model, or may arrange a provisional driven body model, based on an initial machine type information set in advance. By not arranging the driven body model until the machine type information is selected, it can be easily recognized that the machine type information has not been selected by the operator. In addition, by arranging the driven body model based on the initial machine type information set in advance until the machine type information is selected, in the case of the actual machine type matching the initial machine type, the operator can skip input. In the case of the machine tool control device 2 controlling one machining device 1, so long as establishing the initial machine type information as machine type information selected via the previous machine type setting unit 12, the input of the operator becomes substantially unnecessary.

The projection image generation unit 23 creates projection images P1, P2 of the driven body models Mh, Mb viewed from the view point according to the view point selection information inputted from the view point selection unit 13. The projection image generation unit 23, so long as creating projection images of the drivers body models Mh, Mb viewed from one view point according to the view point selection information, may sequentially create projection images viewed from a plurality of view points. FIG. 2 simultaneously exemplifies a YZ plane projection image P1 in a case of the view point selection information being a view point in the X-axis direction, and a XZ, plane projection image P2 in a case of the view point selection information being a view point in the Y-axis direction. The projection image generation unit 23 may output the projection image in any image format such as bitmap format and GIF format, for example. By the projection image generation unit 23 generating a projection image viewed from the view point selected by the operator in the view point selection unit 13, verification of the parameters made using the projection image becomes efficient.

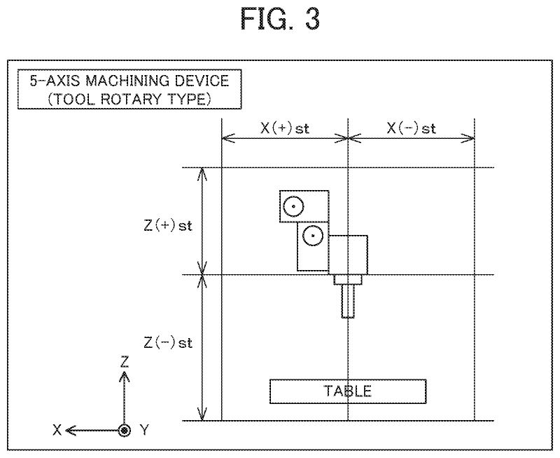

The projection image generation unit 23 preferably includes distance information from the reference point in the projection image, as exemplified in FIG. 3. The movement amount and distance can be illustrated by a method using dimension lines and dimension auxiliary lines of a form conforming to the drafting method defined in IS0129-1 or the like. By creating the projection image including the movement amount, etc. by the projection image generation unit 23 in this way, it is possible to relatively easily confirm whether the parameters inputted to the input acceptance unit 10 were appropriate based on the projection image created by the operator.

The projection image generation unit 23 preferably generates an image containing information indicating a coordinate system together with the driven body models Mh, Mb. As the information indicating the coordinate system, similarly to an information used in order to indicate the coordinate system in 3D CAD or the like, it is possible to establish a picture looking at arrows of unit length each indicating the directions of the X axis, Y axis and Z axis from the view point of the projection image, for example. By the projection image including information indicating the coordinate system, it is possible for the operator to easily understand the contents of the projection image.

The projection image generation unit 23 may generate an image including information indicating the coordinate system without including the driven body models, prior to the machine type information being selected by the machine type setting unit 12, or may generate the projection image including the driven body model arranged based on the initial machine type information set in advance. By generating an image including the information indicating the coordinate system without including the driven body model until the machine type information is selected, it can be easily recognized by the operator that the machine type information has not been selected. In addition, by creating a projection image of the driven body model of the initial machine type set in advance until the machine type information is selected, in the case of the actual machine type matching with the initial machine type, it is possible for the operator to skip input.

In addition, the projection image generation unit 23 may be configured so as to generate a projection image after the machine type information is selected by the view point selection unit 13, and in the case of the machine type information not being selected by the view point selection unit 13, may generate a projection image viewing from the initial view point set in advance. By the projection image generation unit 23 generating a projection image viewed from the initial view point and displaying on the display device 50, it becomes easy for the operator to select a more preferable view point.

The display control unit 30 has a projection image display unit 31 which displays a projection image generated by the projection image generation unit 23, and an input guidance display unit 32 which guides input of parameters to the input acceptance unit 10 of the operator.

The projection image display unit 31 causes the projection image generated by the projection image generation unit 23 to be displayed on the display device 50. In a case of displaying the projection image by the projection image display unit 31, an area displaying the projection image by the projection image display unit 31 may be secured at part of the screen of the display device 50, and perform display or the like of input assisting at least one of the machine type setting unit 12 and view point selection unit 13 at another area.

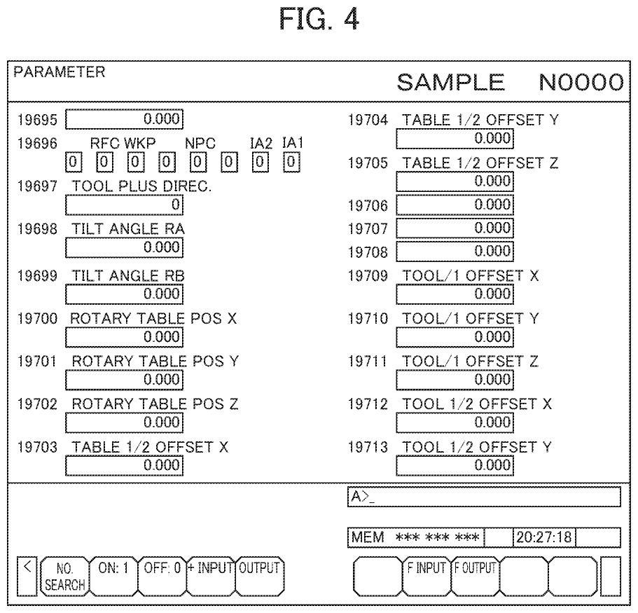

The input guidance display unit 32 displays an input screen which guides the input of the operator designating operating conditions of each drive axis Ax, Ay, Az, Ab, Ac. The input screen displayed by the input guidance display unit 32, as exemplified in FIG. 4, can be established as a screen displaying a box for inputting parameters. In addition, the input guidance display unit preferably performs display for guiding the input to the view point selection unit 13, and input to the machine type setting unit 12. Display of these may be simultaneously performed on the same screen, and may be configured so that input contents for guidance changes by switching the screen (page). At the same time as the display of the projection image by the projection image display unit 31, in the case of performing display for guiding the input to the view point selection unit 13 or input to the machine type setting unit 12, it is preferable to perform input/output of information without delay with the modeling unit 20 and cause the projection image to change in real time.

The input device 40 is a device for inputting information to the input acceptance unit 10, and can be configured by a keyboard, mouse, touch sensor or the like, for example.

The display device 50 is a device displaying the projection image of the driven body model Mh, Mb and input screen by the display control unit, and can be configured by a liquid crystal display panel, organic EL display panel or the like, for example. In addition, the input device 40 and display device 50 may be configured integrally as in a touch panel, for example.

In the above way, the machine tool control device 2 and the machine tool 100 including the machine tool control device 2 according to the present embodiment include the modeling unit 20 having the driven body arrangement unit 22 which arranges the driven body models Mh, Mb on virtual 3D space based on the parameters inputted in the parameter setting unit 11, and the projection image generation unit 23 which generates the projection images P1, P2 of the driven body models Mh, Mb arranged by the driven body arrangement unit 22; therefore, it is possible to relatively easily confirm whether the parameters inputted in the parameter setting unit 11 are appropriate by confirming the projection images P1, 22.

Although an embodiment of the present disclosure has been explained above, the present invention is not to be limited to the aforementioned embodiment. In addition, the effects described in the present embodiment are merely listing the most preferred effects produced from the present invention, and the effects from the present invention are not limited to those described in the present embodiment.

The machine tool control device according to the present disclosure may be a configuration without a display unit, and that outputs data of the projection images to an external device such as a server, for example.

The machine tool control device according to the present disclosure, in the case of specially designing for a specific machining device, may be made a configuration having a machine information processing unit that stores only machine type information of a machining device specially designed, without having a machine type setting unit.

The machine tool control device according to the present disclosure may be made a configuration without a view point selection unit, and having an image generation unit that creates a projection image viewed from one or a plurality of view points decided in advance.

In the machine tool control device according to the present disclosure, the image generation unit may generate a projection image without information indicating a coordinate system. In this case, the machine tool control device preferably has a configuration which displays information indicating a coordinate system together with the projection image.

### EXPLANATION OF REFERENCE NUMERALS

1 machining device
2 machine tool control device
10 input acceptance unit
11 parameter setting unit
12 machine type setting unit
13 view point selection unit
20 modeling unit
21 machine information processing unit
22 driven body arrangement unit
23 projection image generation unit
30 display control unit
31 projection image display unit
32 input guidance display unit
40 input device
50 display device
100 machine tool

What is claimed is:

1. A machine tool control device which controls a machine tool having a plurality o£ drive axes, the machine tool control device comprising:
an input acceptance unit which accepts an input from outside; and
a modeling unit which models a driven body which is driven by the drive axes on virtual 3D space,
wherein the input acceptance unit has a parameter setting unit in which a parameter designating an operating condition of the plurality of drive axes is inputted, and
wherein the modeling unit includes:
a driven body arrangement unit which arranges a model of the driven body on the virtual 3D space, based on the parameter inputted in the parameter setting unit, and
a projection image generation unit which generates a projection image of the model of the driven body arranged by the driven body arrangement unit.

2. The machine tool control device according to claim 1,
wherein the modeling unit further includes a machine information processing unit which stores a plurality of machine type information sets that specify a configuration of the plurality of drive axes,
wherein the input acceptance unit further includes a machine type setting unit which accepts a selection of any of the plurality of machine type information sets, and
wherein the driven body arrangement unit arranges the model of the driven body based on the machine type information set selected by the machine type setting unit.

3. The machine tool control device according to claim 2, wherein the projection image generation unit generates an image including information that indicates a coordinate system without the model of the driven body, prior to the machine type information set being selected by the machine type setting unit.

4. The machine tool control device according to claim 2, wherein the driven body arrangement unit arranges the model of the driven body, based on an initial machine type information set which is set in advance, prior to the machine type information set being selected by the machine type setting unit.

5. The machine tool control device according to claim 1,
wherein the input acceptance unit further includes a view point selection unit which accepts a selection of a view point in the virtual 3D space, and
wherein the projection image generation unit generates a projection image of the model of the driven body as viewed from the view point selected by the view point selection unit.

6. The machine tool control device according to claim 1, further comprising a display control unit which displays the projection image generated by the projection image generation unit.

7. A machine tool comprising:
a machine tool control device according to claim 1; and
a plurality of drive axes driven by the machine tool control device.
